(19) United States
(12) Patent Application Publication
(10) Pub. No.: US 2022/0057324 A1
(43) Pub. Date: Feb. 24, 2022

(54) THERMAL CONTROL OF A SENSOR DEVICE

(71) Applicant: Robert Bosch GmbH, Stuttgart (DE)

(72) Inventors: Andreas Baumgartner, Auenstein (DE); Sina Fella, Neuenstadt (DE); Stefan Kuntz, Flein (DE); Wolfgang Welsch, Heidelberg (DE)

(21) Appl. No.: 17/420,375

(22) PCT Filed: Feb. 11, 2020
(86) PCT No.: PCT/EP2020/053406

§ 371 Date: Jul. 1, 2021

(30) Foreign Application Priority Data
Mar. 12, 2019 (DE) 10 2019 203 318.0

(51) Int. Cl. G01N 21/47; B60W 40/06

(52) U.S. Cl. CPC G01N 21/4738; B60W 40/06; B60W 2420/40; G01N 2201/1211; G01N 2201/062

(57) ABSTRACT

A method for operating a sensor device for determining a road condition. Beams of at least one beam source are generated and emitted into a scanning area. Beams that are scattered or reflected back from the scanning area are ascertained by at least one detector and evaluated for determining the road condition with the aid of the control unit coupled to the detector. Temperature-dependent influences on at least one component of the sensor device are ascertained with the aid of at least one sensor. The temperature-dependent influences on the component of the sensor device are compensated for by a heating device and/or a cooling device and/or during the evaluation by the control unit. A control unit and a computer program are also described.

### FIELD

The present invention relates to a method for operating a sensor device for determining a road condition, in which beams of at least one beam source are generated and emitted into a scanning area, beams that are scattered back or reflected from the scanning area are ascertained by at least one detector and evaluated for determining the road condition with the aid of the control unit coupled to the detector, and it relates to a control unit and a computer program.

### BACKGROUND INFORMATION

To safely operate highly automated vehicles, a precise knowledge of the road condition is necessary. The friction coefficient of the road is in particular influenced by intermediate media between the vehicle tires and the roadway.

Intermediate media of this type may be water, ice, snow or contaminations of the roadway. The detection of these media may take place with the aid of optical sensors that emit beams, for example in the infrared wavelength range, and receive the beams that are scattered back or reflected. The received measured data of the detector may be subsequently evaluated to obtain a road condition.

In addition to the beam sources, which are usually implemented as semiconductors, the detectors as well as other components of the sensor have temperature dependencies that may have an effect on the accuracies of the sensor. For example, the radiation power of the semiconductor light sources may decrease with increasing temperature. The temperature of the semiconductor light sources also has an effect on the emitted wavelength range. In the case of detectors, increasing temperature may have a negative effect on the noise behavior, or the sensitivity may decrease with increasing temperature.

### SUMMARY

An object of the present invention is to provide a method and a control unit for compensating for thermal influences of a sensor device in a technically simple manner.

This object may be achieved with the aid of example embodiments of the present invention. Advantageous embodiments of the present invention are disclosed herein.

According to one aspect of the present invention, a method for operating a sensor device for determining a road condition is provided. In accordance with an example embodiment of the present invention, the sensor device includes at least one beam source for generating beams that are emitted into a scanning area. Beams that are scattered back or reflected from the scanning area are ascertained by at least one detector and evaluated for determining the road condition with the aid of a control unit coupled to the detector.

Temperature-dependent influences on at least one component of the sensor device are ascertained with the aid of at least one sensor, the temperature-dependent influences on the component of the sensor device being compensated for by a heating device and/or a cooling device and/or during the evaluation by the control unit.

According to a further aspect of the present invention, a control unit is provided, the control unit being configured to carry out the method.

According to one aspect of the present invention, a computer program is moreover provided including instructions which, when the computer program is carried out by a control unit, prompt same to carry out the method.

The control unit may be preferably a vehicle-side or a device-side control unit. In particular, the control unit may be designed as a modular integral part of the sensor device.

The sensor device may be preferably used in vehicles or infrastructure equipment to determine a road condition. In particular, the sensor device may be operated with the aid of the method at a constant accuracy in a wide temperature range. A temperature range of this type may be between −40° C. and +85° C., for example.

In particular, the method may be used for vehicles that are operable according to the definition of the German Federal Highway Research Institute in an assisted, semi-automated, highly automated and/or fully automated or driverless manner.

The heating device may involve a Peltier element, an electrical resistance heater and the like. A passive cooling element, a cooling element that is actively cooled by a ventilator, a liquid cooling system or a water cooling system, an absorption cooler, a Peltier element and the like may be used as the cooling device. A Peltier element may be used as a combined cooling and heating device that is connected to the control unit and adjustable by the control unit to a cooling mode or a heating mode.

The compensation for the thermal influences may also take place at the evaluation level. For example, the compensation may be carried out on a software level.

In this way, the temperature-induced fluctuations and deviations of the components of the sensor device, such as for example beam sources, detectors, diodes, resistors and the like, may be taken into account or compensated for.

According to one specific embodiment of the present invention, the component of the sensor device is situated on at least one sufficiently thermally conductive circuit board, the circuit board and/or the component situated on the circuit board is/are thermally adjusted by the heating device and/or cooling device. A circuit board of this type may be used to dissipate thermal energy. The circuit board may be a metallic circuit board, for example. The thermal adjustment of the components situated on the circuit board may thus take place via the circuit board. For example, a temperature stabilization of this type may take place by one or several Peltier element(s) that are situated as closely as possible to the components to be thermally stabilized. In particular, the heating elements and/or cooling elements may be situated together with the components of the sensor device in a shared area of the circuit board or separately in a second area of the circuit board.

According to a further specific embodiment of the present invention, a temperature of the at least one beam source and/or of the circuit board and/or of the detector is measured by at least one temperature sensor and received by the control unit. The temperature sensor may be a thermal element, a pyrometer or a resistance sensor, for example. In particular, the temperature sensor may measure the temperature of the particular component and/or of the circuit board in the area of the component. The ascertained measured data of the temperature sensor may be received by the control unit and used to evaluate data for determining the road condition.

According to a further specific embodiment of the present invention, the temperature is used to ascertain a radiation power of the generated beams in a mathematical function and/or in a simulation and/or in a temperature radiation power characteristic curve. The knowledge of the emitted radiation power is essential for evaluating the intensities in the road condition determination in an error-free and precise manner.

A temperature radiation power characteristic curve of the light sources or beam sources used in the sensor device may be stored in a table, which is accessed with the aid of interpolation, for example. By measuring the temperature of the particular beam sources, the temperature-induced deviation of the radiation power of the beam sources, with regard to a calibrated value at a known temperature, may be ascertained. Alternatively or additionally to the table, the radiation power of the beam sources may be computed based on the temperature. This may take place using algorithms, simulation models and the like. The thermal influence on the components may thus be taken into account, when determining the road condition, based on the temperature measurement with the aid of the control unit.

According to a further exemplary embodiment of the present invention, the measured temperature is used to take into account a temperature-dependent wavelength shift of the beam source and/or to take into account the thermal influences on the detector. Detectors may also typically have temperature effects, such as quantum efficiency, shunt resistances of the photodiode and the like. The measured temperature of the at least one detector may correct the ascertained measured values of the detector and thus increase the accuracy of the measurements.

The wavelength shift of the central wavelength via the temperature during the emission of the beams by the beam sources may be taken into account in a software-based manner by the control unit in the algorithm and/or counteracted in a hardware-based manner by adjusting the temperature of the beam sources with the aid of the heating device and/or cooling device.

In particular, a temperature compensation with the aid of the heating device and/or cooling device may be necessary, if it is not possible to adjust the algorithm for determining the road condition with the aid of the control unit in the required temperature range.

According to a further exemplary embodiment of the present invention, the radiation power of the generated beams is measured by an intensity sensor and received by the control unit. Alternatively to an indirect ascertainment of the radiation power by measuring the temperature of the beam sources, the radiation power may be directly ascertained by the at least one intensity sensor. The intensity sensor may be, for example, a photodiode, a CMOS sensor, a CCD sensor and the like. The radiation power may thus be measured by the intensity sensor directly, in advance or with not radiation being sent to the ground.

The temperature compensation of the intensity is only necessary if the deviations due to intensity changes may no longer be sufficiently taken into account by the computer program. This may take place, for example, if a lower threshold value of the signal-to-noise ratio of the signal is fallen below.

Furthermore, the temperature compensation may be necessary, if the requirements on the accuracy of the data being input into the computer program are higher than the achieved accuracy without temperature compensation. Alternatively or additionally, the temperature stabilization of the sensor device may be preferably used to comply with safety requirements with regard to eye safety.

The ascertained power of the beams may be determined with the aid of a monitoring photodiode of this type, which measures the optical power of the light source, and forwarded to the control unit as a reference signal.

According to a further specific embodiment of the present invention, the radiation power of the generated beams is measured directly at the beam source, indirectly via a beam-guiding connection and/or at a scattered radiation of the beam source with the aid of the intensity sensor. In one technically simple embodiment, the intensity sensor may be positioned directly next to the beam source and use some of the emitted beams and/or the scattered radiation of the beam source to ascertain the radiation power. Furthermore, a beam-guiding connection from the at least one beam source to the intensity sensor may be established. This may be implemented, for example, with the aid of beam splitters, fiber optic light guides and the like.

According to a further specific embodiment of the present invention, a temperature dependency of the intensity sensor is compensated for with the aid of a mathematical function and/or a comparison chart. In this way, temperature-dependent influences of the photodiode characteristics on the signal may be compensated for. For example, a wavelength-dependent temperature sensitivity characteristic curve may be used to take this into account. Wavelength ranges that are not at the edge of the sensitivity range of the detector may thus be advantageously taken into account.

According to a further aspect of the present invention, a sensor device is provided, the sensor device being connectable to a control unit for carrying out the method. The sensor device includes a circuit board having at least one beam source for generating beams and for emitting the beams into a scanning area and having at least one detector for receiving the beams reflected or scattered from the scanning area. Thermal influences on the sensor device are ascertainable with the aid of at least one sensor. The thermal influences on the components of the sensor device are ascertainable in particular. The components of the sensor device may be, for example, beam sources, such as for example LEDs or semiconductor lasers, detectors, resistors, photodiodes and the like.

The sensor device may preferably provide measured data for carrying out a road condition determination with the aid of the control unit. The at least one sensor may be a temperature sensor and/or an intensity sensor. In this way, the temperature and/or the influence of the temperature on the beam sources may be ascertained with the aid of the at least one sensor of the sensor device. Knowledge of the thermal influences on the components may be used to compensate for these influences.

According to one exemplary embodiment of the present invention, the at least one sensor is designed as a temperature sensor and/or as an intensity sensor. In this way, direct or indirect influences of a changing operating temperature of the components may be ascertained. Alternatively or additionally, the at least one beam source may have a central wavelength that is temperature-independent. In particular, only the radiation power of the at least one beam source may be dependent on the temperature, so that compensating only for the radiation power is necessary. A beam source of this type may be designed as a DFB laser, for example. In this way, compensating for the wavelength shift may be dispensed with.

According to a further exemplary embodiment of the present invention, at least one scattered-light protection is situated in the area of the at least one detector. The scattered-light protection may preferably protect the detector at the edges or laterally against scattered-light incidence. In this way, it is possible to situate the detector adjacently to the beam sources, so that the sensor device may be designed particularly compactly.

According to a further specific embodiment of the present invention, at least one bandpass filter is situated in the beam path of the beams that are reflected or scattered back from the scanning area. The at least one bandpass filter may be situated in the beam path upstream from the detector or downstream from the at least one beam source.

A bandpass filter may be preferably situated upstream from the detector that transmits multiple narrow, desired wavelength ranges. It is possible to reduce the number of the components utilized in this specific embodiment by using a multi-wavelength bandpass filter of this type. In the case of a bandpass filter of this type, the use of multiple detectors each having a filter or the variation of the filter over time, such as for example via a Fabry-Perot filter, may be dispensed with.

According to a further specific embodiment of the present invention, the at least one bandpass filter is situated at the scattered-light protection of the detector, the bandpass filter, the scattered-light protection, and the detector being connected to one another. This allows for a compact detector unit to be implemented. The scattered-light protection may be designed as a housing that is open on at least one side. The open side of the scattered-light protection may be covered by at least one bandpass filter. The at least one detector may be positioned in the scattered-light protection.

In a further embodiment of the present invention, relatively broadband light sources, such as for example LEDs, may be used as beam sources. These broadband light sources may be combined with narrowband bandpass filters that transmit a temperature-independent wavelength range at a sufficient approximation. The resulting radiation power may indeed still change, but not the wavelength range transmitted by the bandpass filter to the detector.

In the following, preferred exemplary embodiments of the present invention are elucidated in greater detail with reference to the highly simplified schematic illustrations.

### BRIEF DESCRIPTION OF THE DRAWINGS

FIG. 1 shows a schematic top view of a sensor device according to one specific embodiment of the present invention.

FIG. 2 shows a schematic sectional illustration of the sensor device from FIG. 1.

### DETAILED DESCRIPTION OF EXAMPLE EMBODIMENTS

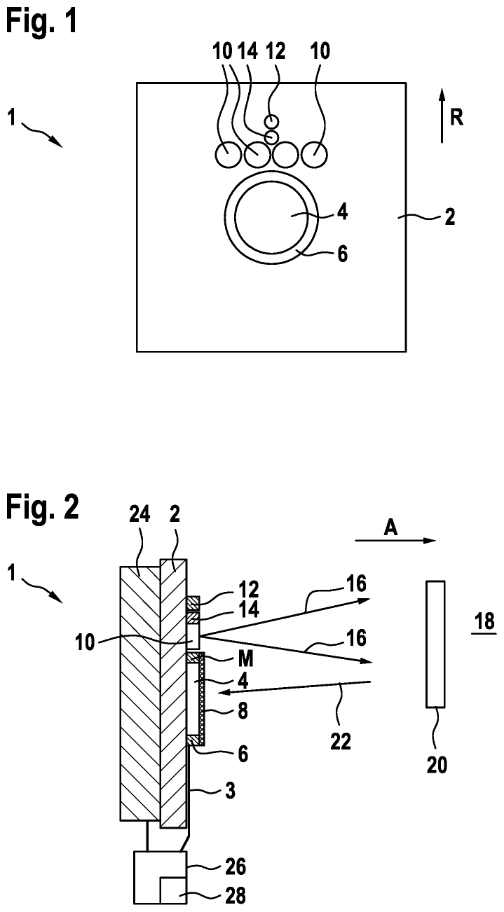

FIG. 1 shows a schematic top view of a sensor device 1 according to one specific embodiment. Sensor device 1 includes a circuit board 2.

Circuit board 2 is shaped as a square by way of example and is manufactured from a material having good thermal conductivity, such as metal, for example. The thermal conductivity of circuit board 2 may thus be increased.

A detector 4 is situated in the center of circuit board 2 of sensor device 1. Detector 4 may be for example designed as a CCD sensor, a CMOS sensor, or as a photodiode, such as for example a PIN photodiode. A scattered-light protection 6 is situated on the periphery around detector 4. If detector 4 has a cylindrical shape, scattered-light protection 6 has a tubular design and accommodates detector 4 on the inside in a form-locked manner. scattered-light protection 6 may have different designs depending on the type of detector 4. For example, scattered-light protection 6 may have a square or rectangular shape in the case of a detector 4 in SMD construction. Alternatively or additionally, scattered-light protection 6 may be already integrated into detector 4. Scattered-light protection 6 delimits detector 4 radially R or along a lateral surface M of detector 4. Detector 4 may include its own reception optics or an integrated reception optics, such as for example a lens.

Scattered-light protection 6 may top detector 4 in axial direction A. A bandpass filter 8 is situated at the end side of scattered-light protection 6. In this way, incident beams may transmit only specific wavelengths to detector 4 through bandpass filter 8.

Sensor device 1 further includes four beam sources 10 situated in a row on circuit board 2. Beam sources 10 may be situated in any arbitrary number and in any arbitrary form on circuit board 2. For example, only one beam source 10 may be provided. Alternatively or additionally, several beam sources 10 may be positioned circularly around scattered-light protection 8. According to the specific embodiment, beam sources 10 are designed as infrared LEDs. Beam sources 10 may be operated successively, i.e., in an order one after another, in an activated and deactivated manner.

A temperature sensor 12 and an intensity sensor 14 are situated on the circuit board adjacent to beam sources 10. Temperature sensor 12 is designed as a resistance temperature sensor, for example, which is thermally conductively coupled to circuit board 2. Since temperature sensor 12 is directly positioned at beam sources 10, the temperature of beam sources 10 may be monitored with the aid of temperature sensor 12.

Intensity sensor 14 is designed as a monitoring photodiode and is capable of measuring the scattered light emitted by beam sources 10 and thus used to monitor the radiation power of beam sources 10.

FIG. 2 shows sensor device 1 from FIG. 1 laterally in a cross section. In this way, the form-locked position of scattered-light protection 8 around detector 4 may be illustrated.

Beam sources 10 generate beams 16 that are emitted into a scanning area 18. Generated beams 16 may be shaped by one or several optics prior to being emitted.

Generated beams 16 may hit obstacles 20, such as for example objects or a roadway, in scanning area 18. Generated beams 16 may be reflected or scattered back from obstacle 20 to sensor device 1. Beams 22, which are reflected or scattered back to sensor device 1, may be subsequently blocked by bandpass filter 8 or transmitted by the bandpass filter to detector 4.

Circuit board 2 is designed in a temperature-stabilized manner according to the exemplary embodiment. For this purpose, a Peltier element 24 is situated on a back side of circuit board 2. Peltier element 24 is used as a cooling element and as a heating element for adjusting a temperature of circuit board 2 and of components 4, 6, 10, 12, 14 situated on circuit board 2.

Beams 22 transmitted to detector 4 may be converted into electrical signals and received by a control unit 26. Control unit 26 is connected to strip conductors 3 of circuit board 2 and may read or activate components 4, 6, 10, 12, 14, 24. In this way, control unit 26 may receive and evaluate the measured values of sensors or detectors 4, 12, 14. In parallel thereto, control unit 26 may activate and control beam sources 10 and Peltier element 24.

Control unit 26 includes a machine-readable memory medium 28 that has a program for operating sensor device 1. In this way, control unit 26 may in particular carry out a road condition determination based on the measured values of detector 4. The measured values of temperature sensor 12 and of intensity sensor 14 may be used by control unit 26 to compensate for the thermal influences on detector 4 and beam sources 10.

The thermal influences may be taken into account by control unit 26 during the evaluation or by adjusting the temperature via Peltier element 24.

1-15. (canceled)

16. A method for operating a sensor device for determining a road condition, the method comprising the following steps:
generating and emitting beams into a scanning area using at least one beam source;
ascertaining beams that are scattered back or reflected from the scanning area using at least one detector; and
evaluating the ascertained beam for determining the road condition using a control unit coupled to the detector;
ascertaining temperature-dependent influences on at least one component of the sensor device using at least one sensor; and
compensating for the temperature-dependent influences on the component of the sensor device by a heating device and/or a cooling device and/or during the evaluation by the control unit.

17. The method as recited in claim 16, wherein the component of the sensor device is situated on at least one thermally conductive circuit board, wherein the circuit board and/or the component situated on the circuit board is thermally adjusted by the heating device and/or the cooling device.

18. The method as recited in claim 16, wherein a temperature of the at least one beam source and/or of the circuit board and/or of the detector, is measured by at least one temperature sensor and received by the control unit.

19. The method as recited in claim 18, wherein the temperature is used to ascertain a radiation power of the generated beams in a mathematical function and/or in a simulation and/or in a temperature radiation power characteristic curve.

20. The method as recited in claim 18, wherein the measured temperature is used to take into account a temperature-dependent wavelength shift of the beam source and/or to take into account thermal influences on the detector.

21. The method as recited in claim 16, wherein a radiation power of the generated beams is measured by an intensity sensor and received by the control unit.

22. The method as recited in claim 21, wherein the radiation power of the generated beams is measured directly at the beam source and/or indirectly via a beam-guiding connection and/or at a scattered radiation of the beam source using the intensity sensor.

23. The method as recited in claim 21, wherein a temperature dependency of the intensity sensor is compensated using a mathematical function and/or a comparison chart.

24. A sensor device, comprising:
at least one circuit board including at least one beam source configured to generate and emit beams into a scanning area, and at least one detector configured to receive beams that are reflected or scattered from the scanning area;
wherein the sensor device is connectable to a control unit configured to:
evaluate the received beams for determining the road condition;
ascertain temperature-dependent influences on at least one component of the sensor device using at least one sensor; and
compensate for the temperature-dependent influences on the component of the sensor device by a heating device and/or a cooling device and/or during the evaluation by the control unit

25. The sensor device as recited in claim 24, wherein the at least one sensor is a temperature sensor and/or as an intensity sensor, and the at least one beam source includes a temperature-independent central wavelength.

26. The sensor device as recited in claim 24, wherein at least one scattered-light protection is situated in an area of the at least one detector.

27. The sensor device as recited in claim 26, wherein at least one bandpass filter is situated in a beam path of the beams that are reflected or scattered back from the scanning.

28. The sensor device as recited in claim 27, wherein the at least one bandpass filter is situated at the scattered-light protection of the detector, the bandpass filter, the scattered-light protection, and the detector being connected to one another.

29. A control unit configured to operate a sensor device for determining a road condition, the control unit configured to:
generate and emit beams into a scanning area using at least one beam source;
ascertain beams that are scattered back or reflected from the scanning area using at least one detector; and
evaluate the ascertained beam for determining the road condition;
ascertain temperature-dependent influences on at least one component of the sensor device using at least one sensor; and
compensate for the temperature-dependent influences on the component of the sensor device by a heating device and/or a cooling device and/or during the evaluation by the control unit.

30. A non-transitory machine-readable memory medium on which is stored a computer program including commands for operating a sensor device for determining a road condition, the commands, when executed by a control unit, causing the control unit to perform the following steps:
generating and emitting beams into a scanning area using at least one beam source;
ascertaining beams that are scattered back or reflected from the scanning area by at least one detector; and
evaluating the ascertained beam for determining the road condition;
ascertaining temperature-dependent influences on at least one component of the sensor device using at least one sensor; and
compensating for the temperature-dependent influences on the component of the sensor device by a heating device and/or a cooling device and/or during the evaluation by the control unit.
